(19) United States
(12) Patent Application Publication
(10) Pub. No.: US 2023/0230724 A1
(43) Pub. Date: Jul. 20, 2023

(54) Self-Regulating Heater Cable

(71) Applicant: nVent Services GmbH, Schaffhausen (CH)

(72) Inventors: Dong Yu, Fremont, CA (US); Prasad S. Raut, Belmont, CA (US); Mohammad Kazemi, San Jose, CA (US); Heng Lin, Menlo Park, CA (US); Linda D.B. Kiss, San Mateo, CA (US)

(21) Appl. No.: 17/567,506

(22) Filed: Jan. 3, 2022

(51) Int. Cl. H01B 7/42; H01B 7/18

(52) U.S. Cl. CPC H01B 7/428; H01B 7/1875

(57) ABSTRACT

Embodiments of the invention provide self-regulating heater cables having improved heat transfer efficiency as well as improved reliability and endurance. The heater cable assembly includes an outer sheath that surrounds a core. The outer sheath includes a conductive ground layer disposed between an inner jacket and outer jacket. The core includes first and second bus wires configured to carry electrical power and a self-regulating resistive heating element that extends along a path to electrically connect the first and second bus wires and convert electric current into thermal energy. The path can be defined by an electrically insulating material disposed in the core and/or the inner jacket.

### CROSS-REFERENCE TO RELATED APPLICATIONS

Not applicable.

### BACKGROUND OF THE INVENTION

Conventional heater cables rely on resistive heating of a dissipative element (e.g., a resistive wire) to generate heat. In some cases, conventional heating cables can be configured as self-regulating heating cables, wherein the heater cable can maintain a desired temperature, irrespective of changes in temperature in surrounding environment. For example, known self-regulating heater cables generally include a pair of bus wires configured as metal conductors, which are surrounded by a resistive heating element (e.g., a conductive polymeric material) to form a solid, monolithic core. The core is enclosed by an outer sheath including an inner jacket, a metal shield, and an outer jacket to form the heater cable. When a current is applied to the heater cable, the current can flow between the bus wires through the resistive heating element, which generates heat through resistive heating. As the temperature of the core increases, the resistive heating element expands, increasing its electrical resistance and reducing the heat output of the heater cable, which prevents over-heating. Conversely, as the temperature of the core decreases, the resistive heating element contracts, reducing its electrical resistance and increasing the heat output of the heater cable to prevent under-heating.

In some conventional self-regulating heater cable designs, the generation of hot spots or zones within the core can reduce the life of the heater cable. In particular, due to the position of the bus wires within the core, the center of the core can become significantly hotter, as a disproportionate amount of current passes through the center of the core (i.e., the shortest path between the bus wires). This effect can be exacerbated by the fact that the resistive heating element is relatively thick at the center of the core, which reduces heat transfer to the outer sheath. Moreover, to account for the natural expansion and contraction of the resistive heating element, gaps must be provided between the core and the sheath, which can further reduce heat transfer.

### BRIEF SUMMARY

In some embodiments, a self-regulating heater cable assembly includes a core and a sheath surrounding the core. The core includes first and second bus wires configured to carry electrical power and an electrically insulating material disposed between the first and second bus wires. The electrically insulating material is configured to define a path between the first and second bus wires. The core further includes a self-regulating resistive heating element extending along the path formed by the spacer to electrically couple the first and second bus wires, which is configured to convert electric current into thermal energy. The sheath includes an electrically insulating inner jacket in contact with the core, an outer jacket, and a conductive ground layer configured to couple the heater cable to electric ground. The conductive ground layer is disposed between the inner jacket and the outer jacket so as to be physically separated from the core.

In some embodiments, a self-regulating heater cable assembly includes first and second bus wires, a self-regulating resistive heating element, an electrically insulating inner jacket, a conductive ground layer, and an outer jacket. The resistive heating element connects the first and second bus wires, which are configured to carry electrical power and to convert electric current into thermal energy. The electrically insulating inner jacket forms an enclosed path along which the resistive element extends. The conductive ground layer couples the heater cable to electric ground and is physically separated from the resistive heating element and the first and second supply wires by the inner jacket. The outer jacket surrounds the ground layer.

The above features and advantages of the invention will be better understood from the following detailed description taken in conjunction with the accompanying drawings.

### BRIEF DESCRIPTION OF THE DRAWINGS

The drawings described herein constitute part of this specification and includes exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 is a front cross-sectional view of a profile of a self-regulating heater cable according to aspects of the disclosure.

FIG. 2 is a front cross-sectional view of a profile of another self-regulating heater cable according to aspects of the disclosure.

FIG. 3 is a front cross-sectional view of a profile of another self-regulating heater cable according to aspects of the disclosure.

FIG. 4 is a front cross-sectional view of a profile of another self-regulating heater cable according to aspects of the disclosure.

FIG. 5 is a front cross-sectional view of a profile of another self-regulating heater cable according to aspects of the disclosure.

FIG. 6 is a front cross-sectional view of a profile of another self-regulating heater cable according to aspects of the disclosure.

FIG. 7 is a schematic showing a temperature distribution of a known self-regulating heater cable with a monolithic core.

FIG. 8 is a schematic showing a temperature distribution of the self-regulating heater cable of FIG. 1.

FIG. 9 is a schematic showing a temperature distribution of the self-regulating heater cable of FIG. 4.

FIG. 10 is a plot showing the active power of the heater cables of FIGS. 7-9 with respect to passive power.

FIG. 11 is a plot showing the temperature of the heater cables of FIGS. 7-9 with respect to active power.

### DETAILED DESCRIPTION

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus appearances of the phrase “in one embodiment,” “in an embodiment,” and similar language throughout this specification may, but do not necessarily, all refer to the same embodiment.

Embodiments disclosed herein provide heater cables with various configurations of non-monolithic cores. In particular, a heater cable may include various components that are configured to reduce an effective cross-sectional area and increase an effective length of a resistive heating element. For example, in some embodiments a core of a heater cable may be provided with an electrically insulating material (such as a spacer or other material) disposed between bus wires. The insulating material can be configured to define a path for a resistive heating element to extend along, which electrically connects the bus wires and converts electrical current into thermal energy. In some cases, the insulating material may work in conjunction with an inner jacket of an outer sheath to help define the electrical path. In other embodiments, the insulating material may not be present and the inner jacket may be shaped to help define the electrical path. Regardless of the presence of such insulating materials, the configurations described herein can provide a maximum or large contact area between the core and the inner jacket, as compared to previous designs.

Reducing an effective cross-sectional area and increasing an effective length of a resistive heating element can benefit performance, reliability, and longevity of a heater cable. For example, a resistive heating element can be made of a carbon-impregnated polymer having a resistivity that increases with temperature. By reducing the effective cross-sectional area of the resistive heating element, higher concentrations of carbon can be used in the polymer, which can allow for a more stable (e.g., flatter) resistance-temperature (RT) behavior. For example, improved RT performance can help mitigate in-rush current issues. In addition, the shape of the path can be tuned to move the location of a hot zone closer to an outer sheath, and more specifically an inner jacket of the sheath, as compared to conventional designs, which allows for more efficient heat transfer from the core, reduces the temperature of the conductive composite, and increases the operational life of the heater cable. In some cases, hot zones may be reduced.

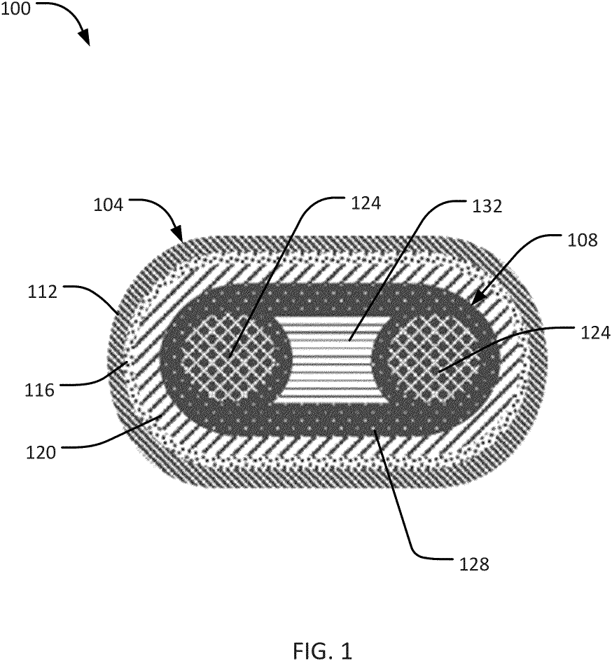

FIG. 1 shows a cross-section of a self-regulating heater cable 100 according to some embodiments. The heater cable 100 includes a protective and thermally conductive outer sheath 104 that surrounds an inner, electrically conductive core 108 along the length of the heater cable 100. In the present embodiment, the heater cable 100 has a generally oblong cross section but other configurations are possible, for example, other polygonal or non-polygonal shapes. The sheath 104 is a multi-layer sheath having a metal shield 116 that is disposed between (i.e., sandwiched between) and inner jacket 120 and an outer jacket 112, although other configurations are possible. The metal shield 116 may be a ground layer comprised of a braid of individual wires, or any other suitable material or composition of materials with sufficient electrical and thermal conductivity, such as foils and other structures suitable for conducting heat and protecting heating cables against punctures and other damage. The inner jacket 120 can be an electrically insulating layer that prevents the metal shield 116 from creating a short circuit path with the core 108.

The core 108 is a self-regulating heating element of the heater cable 100 and generally includes metal conductors or bus wires 124 and a resistive heating element 128. As illustrated, the heater cable 100 includes a pair of bus wires 124 configured as solid metal conductors. In other embodiments, more or fewer bus wires may be provided and any supply wires suitable for a resistive heating application (e.g., braided wire or braided wire bundles) may be used. The resistive heating element 128 is configured to at least partially surround and electrically connect with each of the bus wires 124 to provide an electrical path therebetween, and is preferably made of a flexible, conductive material that can maintain its structural integrity while allowing the heater cable 100 to be bent or flexed into a desired shape. In some embodiments, an electrically conductive ink or a similar electrically conductive material (e.g., silver paint, conductive epoxy) can applied to the bus wires 124 to facilitate electrical contact between the resistive heating element 128 and the bus wires 124.

Generally, a resistive element resists the flow of current between bus wires and generates heat as a byproduct. The amount of heat generated by the resistive element increases with the resistance of the resistive element. That is, during operation of the heater cable 100, a voltage is applied between the bus wires 124 (i.e., establishing a voltage differential between the bus wires 124), causing current to flow between the bus wires 124 via the resistive heating element 128, thereby generating heat by resistive dissipation. The heat generated by the resistive heating element 128 is then transferred by radiation and conduction from the resistive heating element 128 through the intervening layers of sheath (e.g., the inner jacket 120 and the metal shield 116) to the outer jacket 112. In some embodiments, the metal shield 116 may be connected to a ground fault protection device (not shown), which can protect against ground faults and may also help the heater cable 100 to deliver heat uniformly to the outer jacket 112 and ultimately to a surface to be heated.

The resistance (R) of a resistive element is governed by Ohms Law and is dependent on a number of factors, including the effective electrical path length of the resistive element (L), the effective cross-sectional area of the resistive element (A), and the resistivity of the resistive element (ρ):

$$R = ρ \frac{L}{A}$$

Under Ohms Law, the resistance of the resistive element is proportional to the resistivity of the element and its length divided by its cross-sectional area. In the present embodiment, the length and the cross-sectional area of the resistive heating element 128 are effectively constant, as the effects of any thermal expansion are negligible. Thus, to provide for the self-regulating properties of the core 108, the resistive heating element 128 must be made of a material having a resistivity that increases with temperature. For example, in the present embodiment, the resistive heating element 128 is a carbon-impregnated polymer (e.g., carbon black), although other suitable materials may alternatively or additionally be used. In this way, as the temperature of the resistive heating element 128 (and of the heater cable 100) increases, so does its resistivity, thereby increasing the resistance of the core 108, reducing the amount of current flowing through the core 108, and ultimately reducing the amount of heat generated (i.e., reducing a rate of heat generation or power). Likewise, as the temperature of the resistive heating element 128 decreases, so does its resistivity, thereby allowing more current to flow and increasing the amount of heat generated.

Furthermore, in some embodiments, a core can include one or more electrically insulating materials (such as non-conductive spacers or other materials) configured to define a path for a resistive element. In this way, the length and the effective cross-sectional area of the resistive element can be tuned to provide a specific resistive characteristic (e.g. a minimum resistance and a maximum resistance) depending on the material of the resistive element, the desired heat generation, and the ambient conditions of a specific application. In some embodiments, insulating material may work in conjunction with an inner jacket to define the path. That is, any insulating material and the inner jacket may be correspondingly shaped to provide a desired path for a resistive element.

For example, in the illustrated embodiment of FIG. 1, an insulating material 132 is provided between the bus wires 124, which can be co-extruded with the resistive heating element 128, or it can be configured as a separate insert (e.g., as a single spacer). Together with the inner jacket 120, the insulating material 132 defines a path along which the resistive heating element 128 extends to electrically couple the bus wires 124. The inclusion of the insulating material 132 has the effect of reducing the effective cross-sectional area and increasing the effective length of the conductive core 108. As a result, for the same resistivity, the resistive heating element 128 of the present embodiment can have a higher resistance compared to conventional designs. Furthermore, the increased electrical path length and reduced cross-sectional area provide for a flatter resistance-temperature (RT) behavior, which can be beneficial in allowing higher heat generation (i.e., power output) at elevated temperatures (e.g., an upper operational temperature range) a better in-rush performance.

Moreover, due to the decreased and more even thickness of the resistive heating element 128 (e.g., as a result of the insulating spacer 132), potential hot zones are moved to the edges of the core 108 so that heat dissipation through the sheath can be improved, which may help to prevent hot zones from forming in the first place and allow the core 108 to run cooler, thus potentially improving or increasing its operating life. Put another way, the resistive heating element 128 can maintain a more even temperature along its length. Conversely, the thickness (i.e., cross-sectional area) can be tuned to place a hot zone at a desired location. For example, with respect to the orientation of FIG. 1, a lower surface of the heater cable 100 may be configured to rest upon a cold surface and increase the heat transfer through the lower surface. Accordingly, the resistive heating element 128 can be made thicker proximate its lower surface to generate more heat at that location and take advantage of the increased heat transfer. In this way, the heater cable 100 can provide directional heating. Relatedly, in either case, due to generally the decreased cross-sectional area, as compared to conventional designs, the effects of thermal expansion can be reduced, allowing for increased contact between the resistive heating element 128 and the inner jacket 120, to achieve more efficient heat transfer therebetween.

In addition, the resistivity and other characteristics can also be modified because of the increased length and cross-sectional area of the resistive heating element. In particular, the amount of material used in the resistive heating element 128 can be reduced, allowing for higher carbon loading (i.e., higher concentrations of carbon black within the base polymer). Increasing carbon loading can improve the ease of manufacturing and increase the resistivity of the resistive heating element 128, which can allow the amount of material used to form the resistive heating element 128 to be reduced even further. Accordingly, the cost of manufacturing can be reduced while allowing the heater cable 100 to be tuned for low power output with reduced carbon loading or reduced cross-sectional area of the core 108, or high-power output and improved in-rush performance with increased carbon loading or increased cross-sectional area of the core 108.

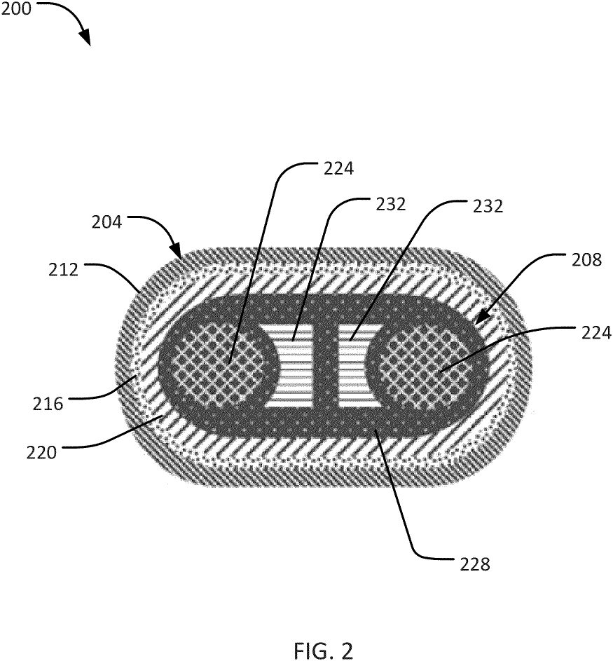

Turning to FIG. 2, a cross-section of another self-regulating heater cable 200, according to some embodiments, is shown. The heater cable 200 is similar to the heater cable 100 and includes a sheath 204 comprising a shield 216, an inner jacket 220, and an outer jacket 212, and an electrically conductive core 208 comprised of a pair of bus wires 224 and a resistive heating element 228 that electrically connects the bus wires 224. However, in the embodiment of FIG. 2, the core 208 includes a multiple sets of insulating material 232 (e.g., a pair of spacers 232) disposed between the bus wires 224. The insulating material 232 is spaced apart to allow a portion of the resistive heating element 228 to extend therebetween. This configuration has similar benefits to those described above with respect to the heater cable 100.

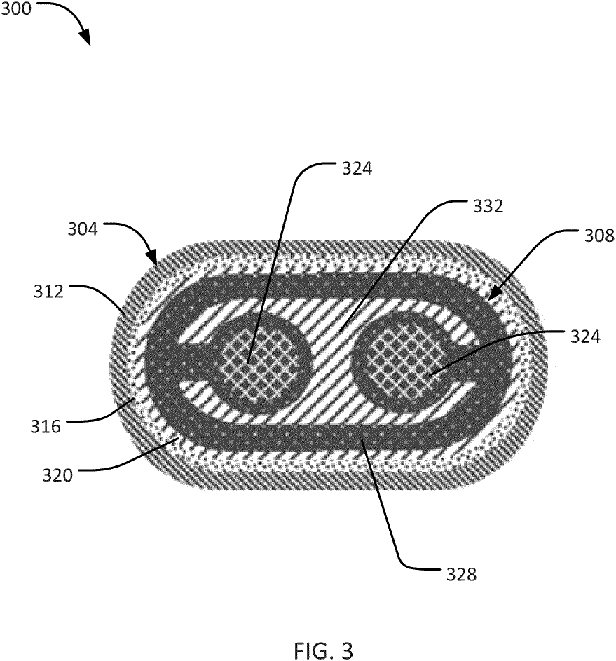

Turning now to FIG. 3, a cross-section of another self-regulating heater cable 300, according to some embodiments, is shown. The heater cable 300 is similar to the heater cable 100 and includes a sheath 304 comprised of a shield 316, an inner jacket 320, and an outer jacket 312, and an electrically conductive core 308 comprised of a pair of bus wires 324 and a resistive heating element 328 that electrically connects the bus wires 324. However, the core 308 includes an insulating material 332 (e.g., a single spacer) that is configured to extend between and partially enclose each of the bus wires 324. This configuration has similar benefits to those described above with respect to the heater cables 100, 200, but provides for an even longer effective length of the resistive heating element 328. The resulting increased conductive core path can present a higher heat transfer contact surface.

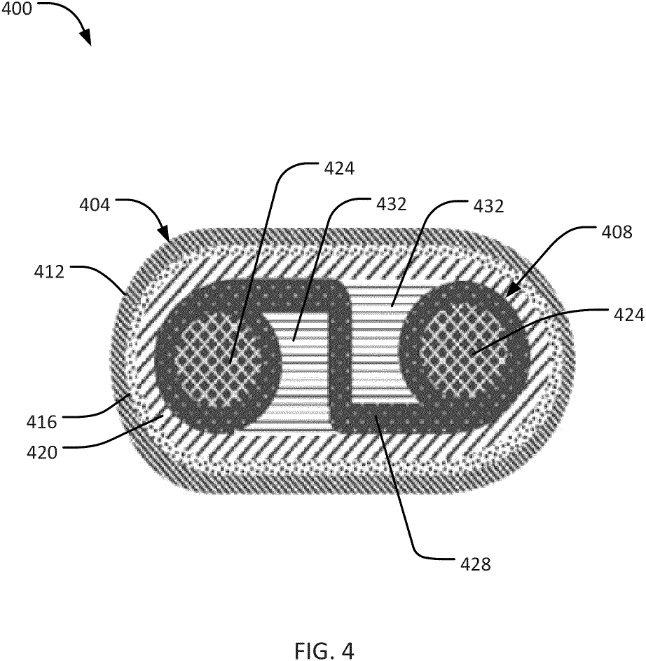

With reference to FIG. 4, a cross-section of another self-regulating heater cable 400, according to some embodiments, is shown. The heater cable 400 is similar to the heater cable 100 and includes a sheath 404 comprised of a shield 416, an inner jacket 420, and an outer jacket 412, and an electrically conductive core 408 comprised of a pair of bus wires 424 and a resistive heating element 428 that electrically connects the bus wires 424. However, the core 408 includes a pair of insulating materials 432 that are spaced apart and configured to partially contact the inner jacket 420, thereby forming a winding path of resistive heating element 428 between the bus wires 424. In this way, the effective cross-sectional area of the resistive heating element 428 can be reduced since there is now a single path for current to flow along. Additionally, the effective length of the resistive heating element 428 is also increased due to the winding nature of the electrical path. This configuration has similar benefits to those described above with respect to the heater cables 100, 200, but provides for a reduced cross-sectional area and even longer effective length of the resistive heating element 428. The resulting increased conductive core path can present a higher heat transfer contact surface. Additionally, the design illustrated in FIG. 4 allows for a thickness of the winding “arms” of the core 108 to be varied to selectively control a location of hot zones at desired sites along the cable 400.

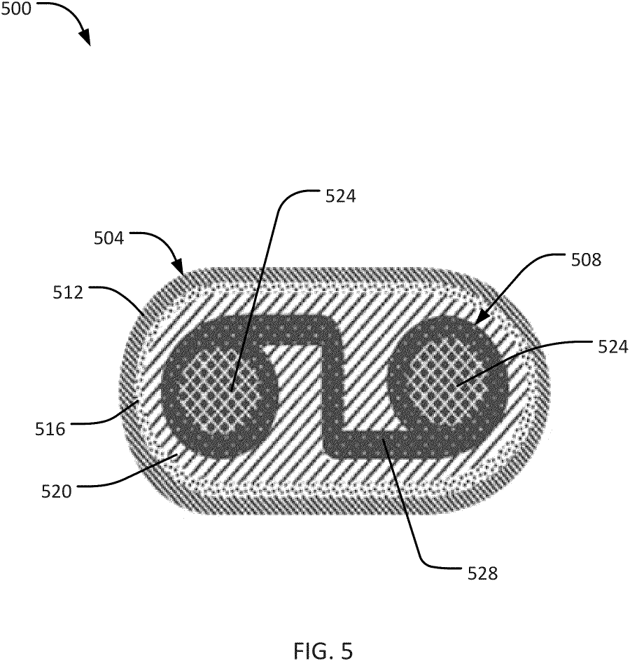

Moving to FIG. 5, a cross-section of another self-regulating heater cable 500, according to some embodiments, is shown. The heater cable 500 is similar to the heater cable 400 and includes a sheath 504 comprised of a shield 416, an inner jacket 520, and an outer jacket 512, and an electrically conductive core 508 comprised of a pair of bus wires 524 and a resistive heating element 528 that electrically connects the bus wires 524. However, the core 508 does not include separate insulating material. Rather, as shown in FIG. 5, the inner jacket 520 is shaped to extend inward toward the core 508 and effectively acts as a spacer to form a winding path between the bus wires 524, along which the resistive heating element 528 extends. This configuration has similar benefits to those described above with respect to the heater cables 100 and 400, but can provide for more efficient heat transfer since the inner jacket 520 surrounds and contacts the resistive heating element 528 on all sides. Furthermore, by eliminating spacers, manufacturing costs can be reduced and efficiency increased by allowing the core 508 and the inner jacket 516 to be co-molded, extruded, or otherwise processed simultaneously.

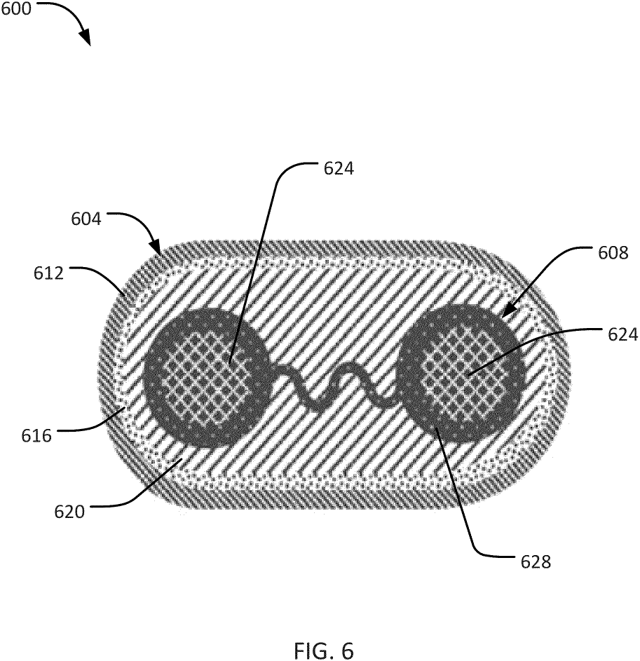

Turning to FIG. 6, a cross-section of another self-regulating heater cable 600, according to some embodiments, is shown. The heater cable 600 is similar to the heater cable 500 and includes a sheath 604 comprised of a shield 616, an inner jacket 620, and an outer jacket 612, and an electrically conductive core 608 comprised of a pair of bus wires 624 and a resistive heating element 628 that electrically connects the bus wires 624, and does not include an insulating spacer. However, the inner jacket 620 is shaped to provide an oscillating path, along which the resistive heating element 628 is disposed, thus further increasing the effective path length of the resistive heating element 628. This configuration has similar benefits to those described above with respect to the heater cables 100 and 500.

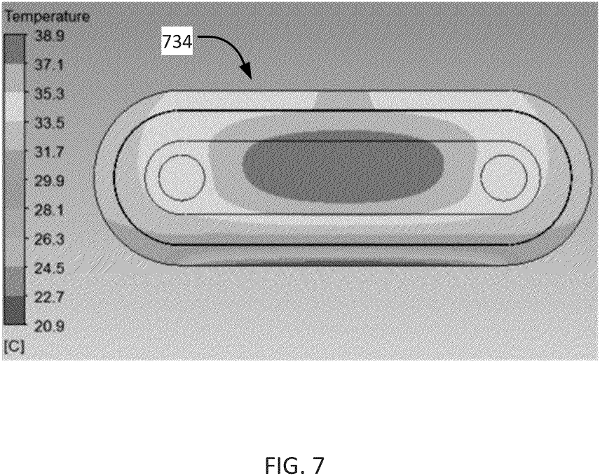

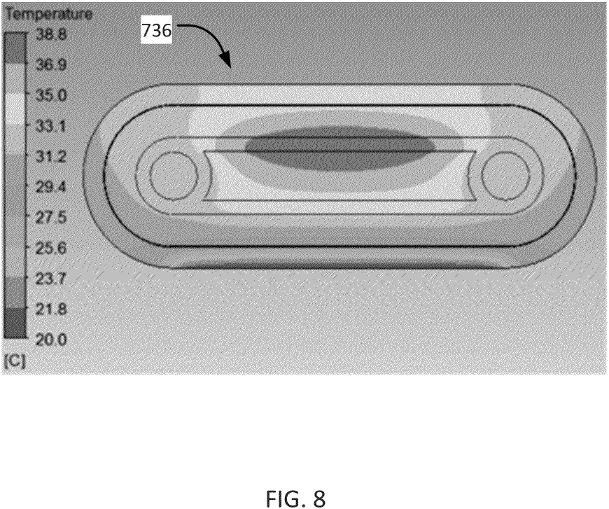

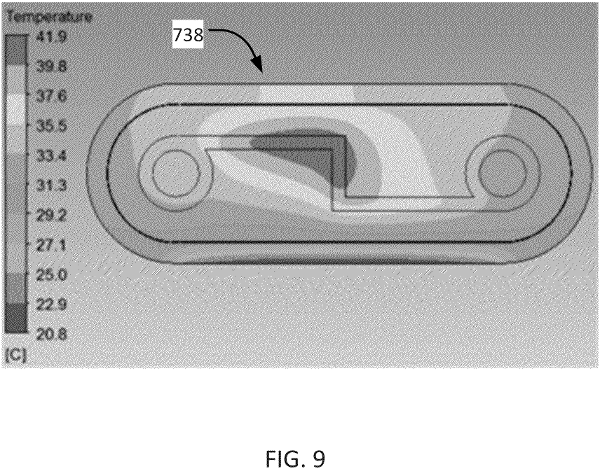

With reference to FIGS. 7-9, temperature distributions for various heater cables according to aspects of the present disclosure are shown compared to a known, monolithic heater cable. More specifically, FIG. 7 shows a temperature distribution for a heater cable 734 configured with a monolithic core, FIG. 8 shows a temperature distribution for a heater cable 736 that is similar to the heater cable 100 of FIG. 1, and FIG. 9 shows a temperature distribution for a heater cable 738 that is similar to the heater cable 400 of FIG. 4. As shown in FIGS. 7-9, under the same power (i.e., current and voltage) the size of the hot zone in the heater cables 736 and 738 is smaller, as compared to the known heater cable 734.

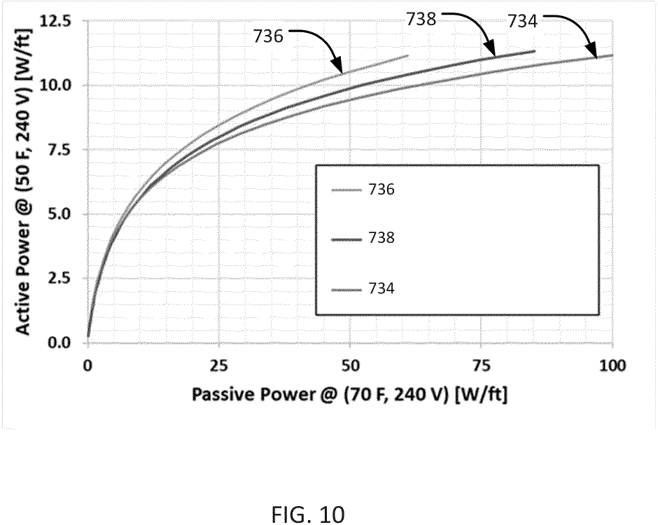

Turning to FIG. 10, the active power of the heater cables 734, 736 and 738 is shown with respect to the passive power. As shown, the heater cables 736 and 738 achieve higher active power for the same passive power as compared to the conventional heater cable 734.

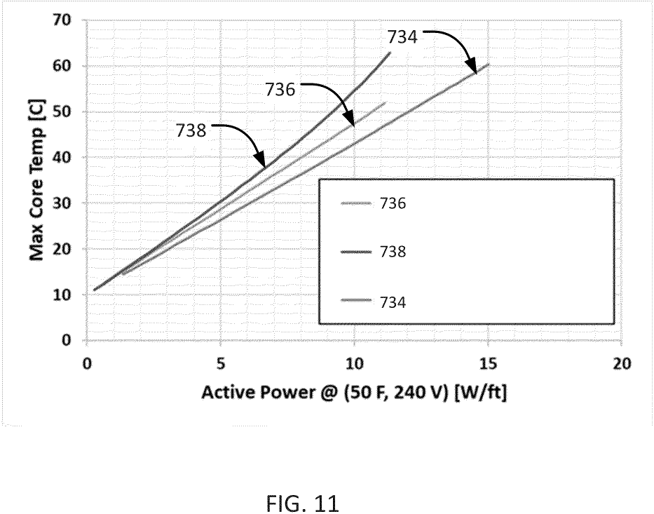

Turning now to FIG. 11, a maximum core temperature of the heater cables 734, 736 and 738 is shown with respect to the active power. As shown, the heater cables 736 and 738 can achieve higher temperatures for the same active power as compared to the conventional heater cable 734.

While there has been illustrated and described what is at present considered to be suitable example embodiments of the present invention, it will be understood by those skilled in the art that various changes and modifications may be made and equivalents may be substituted for elements thereof without departing from the true scope of the invention. The embodiments of the invention described herein are not intended to be exhaustive or to limit the invention to precise forms disclosed. Rather, the embodiments selected for description have been chosen to enable one skilled in the art to practice the invention. Therefore, it is intended that this invention not be limited to the particular embodiments disclosed, but that the invention includes all embodiments falling within the scope of the appended claims.

1. A self-regulating heater cable assembly, the heater cable assembly comprising:
a core including:
first and second bus wires configured to carry electrical power;
an electrically insulating material disposed between the first and second bus wires, the electrically insulating material being configured to define a path between the first and second bus wires;
a self-regulating resistive heating element extending along the path to electrically couple the first and second bus wires, the resistive heating element being configured to convert electric current into thermal energy; and
a sheath surrounding the core, the sheath including:
an electrically insulating inner jacket in contact with the core;
an outer jacket; and
a conductive ground layer configured to couple the heater cable to electric ground, the conductive ground layer being disposed between the inner jacket and the outer jacket.

2. A self-regulating heater cable assembly, the heater cable assembly comprising:
first and second bus wires configured to carry electrical power;
a self-regulating resistive heating element that electrically connects the first and second bus wires and converts electric current into thermal energy;
an electrically insulating inner jacket configured to form an enclosed path along which the resistive heating element extends;
a conductive ground layer that couples the heater cable to electric ground, the ground layer surrounding and physically separated from the resistive heating element and the first and second supply wires by the inner jacket; and
an outer jacket surrounding the ground layer.
